(19) United States
(12) Patent Application Publication
(10) Pub. No.: US 2004/0119737 A1
(43) Pub. Date: Jun. 24, 2004

(54) Methods and apparatuses for advertising based compensation management

(76) Inventor: Philip Smolin, Boulder, CO (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/322,958

(22) Filed: Dec. 18, 2002

(51) Int. Cl. G09G 5/00

(52) U.S. Cl. 345/738; 345/744

(57) ABSTRACT

The present invention provides an advertising based compensation management system. In particular, a user is allowed to customize display parameters for accessing particular data content from a content provider. Based on the parameters, the content provider can calculate a subscription fee or the like.

### FIELD OF THE INVENTION

The present invention relates to accessing data content and, more particularly, to a filter that will allow a user accessing data content to determine compensation options for accessing the data content.

### BACKGROUND OF THE INVENTION

FIG. 1 illustrates a conventional network 100. Network 100 includes at least local display 102, such as a personal computer 102 and at least one data content provider 104, such as a conventional server 104. For purposes of this application, display is used broadly to mean an apparatus that provides data to a user and could be a monitor, a telephone, a television, a radio, or the like. Further, data content provider also is used broadly to refer to an entity that provides the requested data and could be a conventional server, a processor, a dial in voice service, or the like. Connecting display 102 and content provider 104 exists a communication link 106. Communication link 106 could be, for example, conventional bus work, Ethernet connections, local area network connections, wide area network connections, data line, telephone lines, optical cables, coaxial cables, broadcast connections, wireless connections, Internet connections, other World Wide Web connections and the like. For convenience, however, FIG. 1 will be explained assuming a user at personal computer 102 requests data content from conventional server 104 connected by the Internet 106.

Conventionally, when a user at personal computer 102 desires to view data content contained on a networked server 104 (server and content provider are generally used interchangeably), a request is sent from computer 102 to the server 104. Server 104 retrieves the requested content from an associated memory file and downloads, streams, or otherwise transmits the content to computer 102 for display to the user. Transmitting and displaying content from network server 104 to the display on computer 102 is conventional and will not be further explained.

Some content providers, such as www.walmart.com, sell their own goods. These providers typically allow users free access to their content in order to solicit business for themselves and generate revenues through purchases.

Other content providers, however, such as www.cnn.com, offer services. While a news service is shown for illustration purposes, other services could be offered, such as, for example, sports, games, books, reviews, music, video and the like. Traditionally, these providers subsidized their services (hereinafter “subsidized service(s)”) by providing advertisement, such as banner ads, pop up ads, or the like, along with the content. Users do not pay for subsidized service, but rather the advertiser provided subsidy pays for the provider to provide the content to the user.

Some content providers, such as www.dunandbradstreet com, subsidize their service by requiring the user to pay a subscription fee (hereinafter “subscription service(s)”). For example, when a user first accesses the subscription service, the user is typically prompted to provide billing information, which could be a credit card or the like, and an account is generated for the user. The user would then be able to access the subscription service. When the user accesses the subscription service in the future, the server 104 would require the user to identify him or herself. The identification could be via a login, which could contain a password, a file the subscription service embedded in the user's computer, such as a cookie file, the user could be identified by a particular internet address, or the like. Thus, the user pays a subscription fee for access to subscription services. These providers may also subsidize their services by providing advertisement along with the content.

Recently, there has been a downward trend in advertising revenues for content providers. Thus, many subsidized services are closing shop and/or switching from subsidized service to subscription services (hereinafter “transition services”). Many of these transition services have experienced a reduction in users accessing their site because on the margin the users do not wish to pay the subscription fees.

Based on the foregoing, it would be desirous to develop a compensation management system that allows a user to select compensation options which will increase the advertising revenue, subscription revenue, or both.

### SUMMARY OF THE INVENTION

To attain the advantages and in accordance with the purpose of the invention, as embodied and broadly described herein, a method for displaying customized data content to a user based on customized compensation options is provided. The method comprises a user requested data content from a content provider. A customized account of the user is retrieved. The customized account contains parameters relating to display information. The data content is arranged based on the account and transmitted to the user.

The invention also provides compensation selection device that comprises a user interface on a user display allowing the user to input at least one compensation selection input. A processor uses the compensation selection to customize a display input.

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIG. 1 shows a conventional computer architecture;

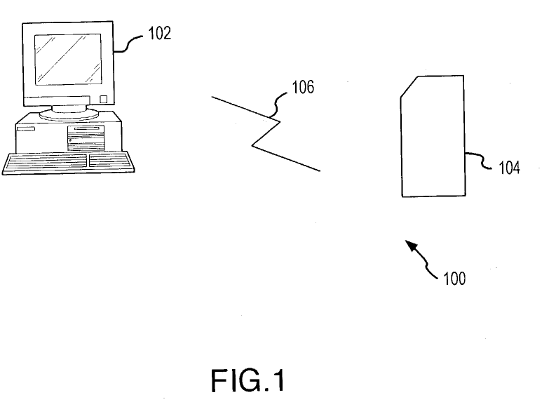

FIG. 2 shows a computer architecture consistent with an embodiment of the present invention;

FIG. 3 shows an embodiment of a user interface consistent with the present invention;

FIG. 4 shows a graphic compensation selection interface consistent with the present invention; and

FIG. 5 is a flowchart illustrative of a method of operation of the present invention;

### DETAILED DESCRIPTION

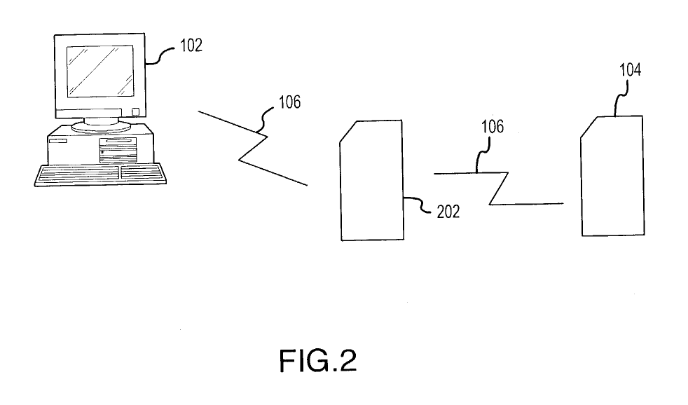

The present invention will be described with reference to FIG. 2 to FIG. 5. While the present invention will be described in the context of the Internet or World Wide Web, one of ordinary skill in the art would understand on reading the disclosure that the present invention could be applied in various local area networks, wide area networks, cable networks, broadband and narrowband networks, optical networks, Ethernet connections, wireless networks, telephone networks, television networks, radio networks, and the like. As shown in FIG. 2, a display, such as personal computer 102, is connected to server 104 using Internet connections 106. Interspersed between computer 102 and server 104 is a selection server 202. Selection server 202, which will be explained further below, could be a stand alone server as shown, incorporated into server 104, or incorporated into computer 102 as a matter of design choice. If used as a separate server data requests to content providers would be routed through selection server 202.

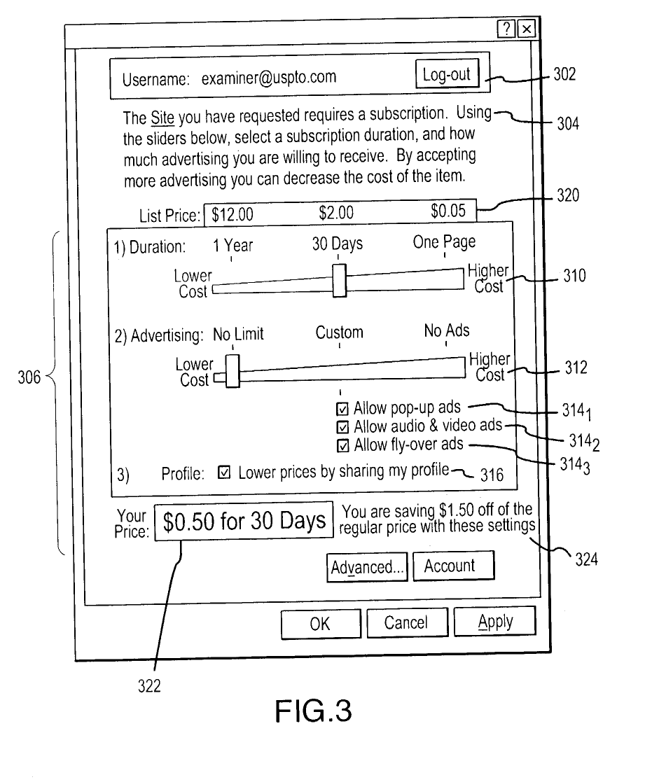

In this case, when a user at computer 102 attempts to access data content contained on server 104, the request is routed to or intercepted by selection server 202. Selection server 202 provides a compensation selection screen 300, as shown in FIG. 3. Compensation selection screen 300 typically, but not necessarily, include a user identification 302 and a description 304. Compensation selection screen 300 also comprises a compensation interface 306.

As shown in FIG. 3, compensation interface 306 includes a duration slide bar 310, an advertising slide bar 312, advertising style selection boxes 314₁₋₃, and profile sharing section box 316. By selecting various options, detailed below, the user can customize how much advertising and what type of advertising they may receive against how much they may pay for viewing the content. Thus, one user can select increased ads with the data content to pay, for example, a reduced fee, and another user can select decreased ads with the data content to pay, for example, an increased fee.

With reference to FIG. 3, compensation selection screen 300 will be further explained. Duration slide bar 310 provides the user with selection of various lengths of the subscription, which are shown as 1 page to 1 year, but could be any time designations. Alternatively, the duration of subscription could be linked to number of visits instead of length of time. Another duration selection could be providing the user with an input field where the number of visits or length of subscription could be entered alpha-numerically by the user via a keyboard, for example. Advertising slide bar 312 provides the user with selection of various amounts and/or types of advertising. For example, the user could select no limits on provided advertising. Alternatively, the user could select limited advertising or no advertising. Where the user sets the selection influences the cost of the subscription. Associated with advertising slide bar 312 are selection boxes 314. Selection boxes 314 allow users to customize the type of advertising they may receive. For example, checking box 314, allows server 104 to provide pop-up ads. While customizing for some ads is shown, other selections not shown are possible, such as selection boxes to allow or not allow recreational ads, to allow or not allow health care ads, or the like are possible.

Selection interface screen 300 also contains a profile selection box 316. Many content providers receive significant revenues from selling profile information and customer lists. Some users elect not to access content providers who sell this type of information. Other users are not concerned with the sale of this information. In order to entice users who would otherwise not request data content from content provider 104, profile selection box 316 allows users to identify whether they wish to allow their information to be recorded or not. Further, profile selection may have one or more possible selections ranging from providing more or less detail regarding the user. These selections could be, zero profile information, general profile information, or detailed profile information. Typically, the more detailed the profile information on the user, the more valuable the information, and the lower the subscription fee.

Compensation selection screen 300 also may include list price information 320. List price information 320 may contain the subscription price for, as shown, a 1 year subscription, a 30 day subscription, and a one page (single access) subscription. In this case, a 1 year subscription without advertising and without profile information may cost $12.00, a 30 day subscription without advertising and without profile information may cost $2.00, and a one page (single access) subscription without advertising and without profile may cost $0.05. The user, however, can customize the subscription by allowing all advertising and providing profile information. Because the content provider can receive revenue for the advertising and for the profile information, the content provider can charge less for this particular user's subscription. As shown in subscription information section 322, the actual subscription in this case $0.50 for a 30 day subscription, which as shown in saving box 324 is a $1.50 savings from the no advertising no profile price. Variations on subscription prices based on customizing could range over various possibilities as a matter of design choice. Once accepted, back office software would bill the user the subscription charge.

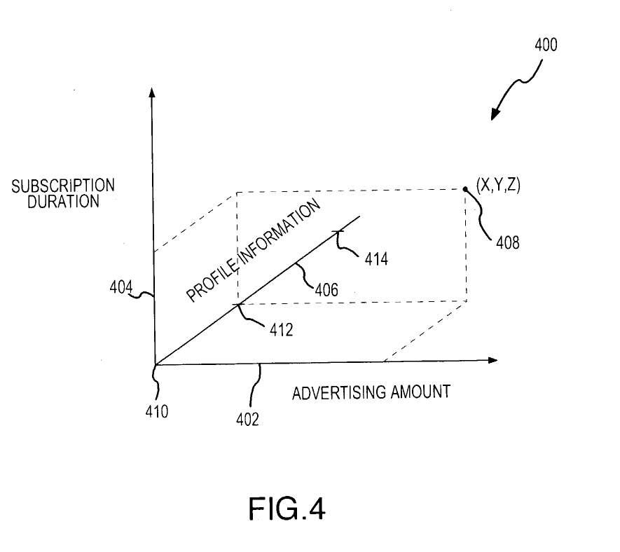

Although shown as slide bars and boxes, compensation selection interface screen 300 could comprise many different selection types, such as radio buttons, two or more dimensional graphs, spectrums, check boxes, stand-alone buttons, menus, pull down menus, dials, alpha-numeric selections, touch tone or the like. For example, FIG. 4 shows a graph 400 illustrative of a 3-dimensional graph. The x-axis 402 could represent amount of advertising, the y-axis 404 could represent duration of subscription, and the z-axis 406 could represent the profile information. In this example, x-axis 402 and y-axis 404 represent a continuous spectrum of possible choices from 0 up. Z-axis 406 provides discrete choices for profile information from 0 information 410, limited information 412, and detailed information 414. Of course, any of the axes could be a spectrum of choices or discrete choices. The subscription cost (or lack thereof) would be determined by a user selecting a point 408 on the graph indicative of the user's preferences. Of course, other graphical interfaces could be used as well as the example should be considered no limiting. Generally, the selection graphics or controls would be designed based on the transmission medium. In other words, graphical displays work well with Internet based systems, but a telephone-based system using POTS, for example, may have touch-tone selections instead.

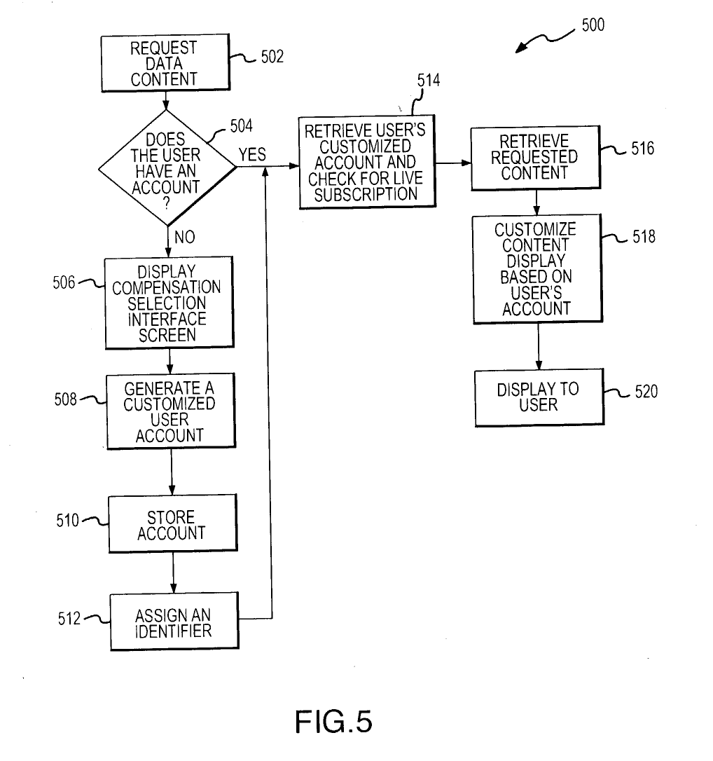

FIG. 5 is a flowchart 500 illustrative of the compensation management system. First, a user initially requests data content from a content provider, step 502. A selection service determines whether the user has an account established, step 504. If the user does not have an account established, then the compensation selection interface screen is provided to the user, step 506. The display could be via images, video, audio, or combination thereof. The user uses the selection interface to generate a customized user account, step 508, which is stored, step 510. The generated customized user account can be a compilation of user inputs relating to proffered selection criteria. A unique identifier is assigned to associate the user and the user's stored account, step 512. The unique identifier could be a file embedded in the user's equipment or a login and password as is known in the art.

After the user generates a customized account, or if step 504 determines the user already had an established account, the users customized account is retrieved from memory using the unique identifier and a check is made to ensure the subscription is live, i.e., has not expired, step 514. If the subscription has expired, the system could prompt the user for a new or extended subscription. Next, the content provider retrieves the requested content, 516, and customizes the display based on the user's account, step 518. Customizing the display could be accomplished by retrieving potential ads from memory or 3^{rd} party servers connected to the network. Once the data content is retrieved and ads are inserted as allowed by the user's account, the data content is downloaded, streamed, or otherwise transmitted back to the user for display, step 520.

As mentioned above, the compensation management system could be implemented in selection server 202 such that content providers 104 have requests directed to their content routed through selection server 202. Alternatively, the compensation management system could be implemented as a software module as part of content provider 104 or display 102.

An embodiment of the present invention and many of its improvements have been described with a degree of particularity. It should be understood that this description has been made by way of example, and that the invention is defined by the scope of the following claims.

We claim:

1. A method for of displaying customized data content to a user based on customized compensation options, the method comprising the steps of:
requesting data content from a content provider;
retrieving a customized account containing parameters of a user requesting the data content;
customizing a display of the requested data content based on the customized account; and
transmitting the display to the user.

2. The method according to claim 1, further comprising:
generating the customized account containing parameters of a user; and
storing the customized account.

3. The method according to claim 2, wherein the generating step comprises:
providing a compensation selection screen to the user containing at least one compensation interface; and
inputting a compensation choice to the at least one compensation interface.

4. The method according to claim 3, further comprising:
calculating a subscription fee to receive the requested data content based on the input choice; and
billing the user the calculated subscription.

5. The method according to claim 1, wherein the customizing step includes inserting non-requested data content to the display.

6. The method according to claim 5, wherein the inserting non-requested data content includes obtaining non-requested data from a 3^{rd} party content provider.

7. The method according to claim 3, wherein the inputting a choice to the at least one compensation interface further comprises at least one of:
selecting an amount of allowed advertising; and
selecting at least one type of allowed advertising.

8. The method according to claim 7, wherein the at least one compensation interface comprises at least one of:
sliding at least one marker on a gradient scale;
clicking on radio buttons;
selecting checkboxes;
clicking on buttons;
inputting alpha information;
inputting numeric information;
inputting alpha-numeric information;
inputting audio information;
inputting touch tone information;
identifying a point on a graphical representation; and
selecting from a menu.

9. The method according to claim 4, further comprising the step of:
displaying the calculated subscription to the user.

10. The method according to claim 9, further comprising the step of:
calculating a subscription savings based on the at least one compensation selection.

11. The method according to claim 1, further comprising the step of:
assigning an identifier the user with the customized account.

12. The method according to claim 11, wherein: the assigned identifier is used to retrieve the customized account.

13. A method for of displaying customized data content to a user based on customized compensation options, the method comprising the steps of:
requesting data content from a content provider by a user,
determining whether the user has a customized compensation account;
if it is determined that the user does not have a customized compensation account, generating a customized compensation account;
obtaining the generated customized compensation account;
customizing a display of the requested data content based on the customized account; and
transmitting the display to the user.

14. The method according to claim 13, wherein the generating step further comprises storing the customized compensation account and the obtaining step comprises retrieving the customized compensation account from storage.

15. The method according to claim 13, wherein the customizing a display step includes inserting non-requested data content into the display.

16. The method according to claim 15, wherein further comprising the step of obtaining non-requested data from a 3^{rd} party.

17. A compensation selection device to customize data content displayed to a user, comprising:
a user display;
a user interface capable of being displayed on the user display;
the user interface including at least one compensation selection input;
a processor; and
a memory, wherein;
the processor is adapted to display the user interface to the user at least the first time the user requests data content from a content provider; and
the processor customizes data content from the content provider based on the at least one compensation selection input.

18. The compensation selection device according to claim 17, wherein the processor is a plurality of networked processor.

19. The compensation selection device according to claim 18, wherein the network comprises at least one of a local area network, a wide area network, the internet, the world wide web, a cable network, an optical network, an Ethernet, a telephone network, a broadcast network, and a wireless network.

20. The compensation selection device according to claim 17, wherein:
the user interface is a graphical user interface; and
the at least one compensation selection input on the graphical user interface is at least one of a slider bar, a spectrum, a radio button, an alpha input, a numeric input, an alpha-numeric input, an audio input, a touch tone input, and a menu.

21. The compensation selection device according to claim 17, wherein the user interface is an audio menu.

22. A computer program product comprising:
a computer usable medium having computer readable code embodied therein for processing data to generate a customized compensation account, the computer usable medium comprising:
a determining module configured to determine whether a user requesting data content from a content provider has a customized account;
a generating module configured to generate a customized account by displaying a compensation selection interface and receiving input from the user relating to compensation when the determination module determines the user does not have the customized account;
a memory module configured to store the generated customized account;
a retrieving module configured to retrieve a customized account from the memory module based on the user requesting data content from the content provider;
a customization module configured to customize a display containing the requested data content based on the retrieved customized account; and
a transmitting module configured to transmit the customized display to the requesting user.

23. The computer program product according to claim 22, further comprising:
a subscription calculation module configured to calculate a subscription fee chargeable to the user based on the input received from the compensation selection interface.

24. The computer program product according to claim 23, further comprising:
a billing module configured to bill the user the calculated subscription fee.

25. The computer program product according to claim 22, wherein the customization display module is further configured to incorporate non-requested data content into the display.

26. The computer program product according to claim 25, wherein the customization display module is further configured to obtain non-requested data content from at least one 3^{rd} party.

27. A system to allow a user to customize subscription services, comprising:
a user terminal having a display,
a content provider;
a network connecting the user terminal and the content provider,
means for obtaining compensation options for subscription services; and
means for customizing data content displayed to a user based on the inputted compensation options.

28. The system according to claim 27, wherein the means for obtaining compensation options comprises a graphical user interface displayed at the user terminal adapted to receive input relating to at least one preference of a user.

29. The system according to claim 28, wherein the graphical user interface has at least one input comprising at least one of a slider bar, a spectrum, a radio button, a checkbox, a button, an alpha input, a numeric input, an alpha-numeric input, an audio input, a touch tone input, and a menu.

30. The system according to claim 27, further comprising:
means for generating a subscription fee based on the inputted compensation options.

31. The system according to claim 27, wherein the means for obtaining compensation options comprises a selection server adapted to display a graphical user interface on the user terminal.

32. The system according to claim 27, wherein the means for obtaining comprises means for inputting.
